(19) United States
(12) Patent Application Publication
(10) Pub. No.: US 2009/0122648 A1
(43) Pub. Date: May 14, 2009

(54) ACOUSTIC MOBILITY AID FOR THE VISUALLY IMPAIRED

(75) Inventors: David C. Mountain, Byfield, MA (US); Cameron J. Morland, Cambridge, MA (US)

Correspondence Address: BAINWOOD HUANG & ASSOCIATES LLC, 2 CONNECTOR ROAD, WESTBOROUGH, MA, 01581, US

(73) Assignee: Trustees of Boston University, Boston, MA (US)

(21) Appl. No.: 12/269,159

(22) Filed: Nov. 12, 2008

Related U.S. Application Data
(60) Provisional application No. 60/987,265, filed on Nov. 12, 2007.

(51) Int. Cl. G01S 15/00

(52) U.S. Cl. 367/93

(57) ABSTRACT

A wide-band sonar system can be used as a mobility aid by the visually impaired. The system includes an acoustic source and a pair of miniature microphone arrays with frequency-dependent beam patterns designed to mimic the properties of the human ear. Each microphone is preferably mounted near a respective ear of the user. In one embodiment the source has a bandwidth of 30-50 kHz and uses a waveform that preferably optimizes the time-bandwidth product. A heterodyning technique is used to shift the received signal down to the audible range (20 Hz-20 kHz), after which it is presented to the user through open-style earphones. The acoustic source and microphone arrays are mounted on the user's head so that the system will always be aligned therewith—as an example, they may be mounted near the user's ears on conventional eyeglass frames or a similar mounting device.

### CROSS REFERENCE TO RELATED APPLICATIONS

This Patent Application claims the benefit under 35 U.S.C. §119(e) of U.S. Provisional Patent Application No. 60/987,265 filed on Nov. 12, 2007 entitled “Acoustic Mobility Aid for the Visually Impaired”, the contents and teachings of which are hereby incorporated by reference in their entirety.

### BACKGROUND

According to the American Foundation for the Blind (2005), at least 1.3 million people, or 0.5% of the population of the United States, are legally blind, but some estimates are even higher. Mobility aids in this market include canes, trained guide dogs, and electronic aids.

The long cane is in widespread use. It is quite inexpensive and provides surprisingly rich sensory information. Its main limitations are having a small sensory area and a range of only about 90-120 cm (3-4 feet). At walking speed the short range limits them to “last moment” obstacle avoidance.

Guide dogs are the only other technology with a significant number of users (roughly 7000 users in total in the United States). Although they are provided cost-free to users, there is limited availability due to the expense of training, which exceeds $30,000 per dog, with each dog working for between 5 and 12 years. Guide dogs do not navigate over long distances on their own, nor can they determine when it is safe to cross a busy street.

A survey of commercially available electronic mobility aids includes more than a dozen products which detect nearby obstacles using simple range sensors (ultrasonic, laser, or infrared), a robotic guide “dog”, talking compasses, talking signs, and three long-range navigation devices using the Global Positioning System (GPS) for localization and Geographic Information System (GIS) maps. None of these electronic mobility aids are widely used, primarily because they provide little or no improvement in mobility, or have non-intuitive or inconvenient interfaces. GPS has particular difficulties in urban or indoor environments.

### SUMMARY

An acoustic mobility aid is disclosed that operates on the principle of sonar or echo-location, enabling a user to sense objects in his/her environment by sound. The system includes a source of supersonic acoustic signals directed from the user toward surrounding objects, microphones worn by the user to receive reflected acoustic signals, a digital signal processor to perform desired processing of the received acoustic signals and generate audible-range acoustic signals for the user, and headphones worn by the user over which the audible-range acoustic signals are played.

The approach herein differs from other approaches by its combination of a broad-band acoustic source with biologically-inspired acoustic display techniques that are designed to let the user take advantage of their natural ability to localize sound sources in space. Inaudible reflected sounds include spatial and textural information, which are retained by frequency shifting performed to shift the signals to the audible range. From the user's perspective, the device therefore gives the impression of causing objects within range to emit sounds. Users are able to localize objects as well as get some impression of size and surface texture. Since most blind or visually impaired people use “natural” echolocation to some degree (consciously or unconsciously), this is a very intuitive interface.

Since the normal range of human hearing is 20 Hz to 20 kHz, a sonar signal with a bandwidth of 5 kHz to 20 kHz is desirable. It is also preferable that the sonar signal not be audible, and it should avoid exciting any narrow-band resonances in commercially available transducers. Thus in one embodiment the sonar signal has a spectrum in the range of 30 kHz to 50 kHz. For broad-band sonar it is also desirable to minimize the time-bandwidth product, so a Gaussian envelope may be used for example. Using digital synthesis these constraints can easily be met. The sonar echoes are detected using arrays of miniature microphones. For the auditory display, the received signal is time windowed by zeroing signals received immediately after the emitted click as well as signals received after a time interval corresponding to the maximum desired range. The windowing is intended to eliminate direct stimulation of the microphones by the emitting transducer and to emphasize echoes from nearby objects.

The windowed signal is digitally shifted (heterodyned) down (e.g., by 30 kHz) and the resulting audio signal is presented to the user via open tube earphones. The reason for using open earphone is to minimize interference with normal hearing of ambient sound. For one microphone array design, it is desired to have spectral notches that are in the 5-10 kHz range after heterodyning. This implies a minimum array aperture of 8.5 mm.

The system is assembled out of the individual components. It may employ a frame mimicking standard eyeglass frames, chosen to have sufficient space to mount the microphones and preamplifier circuits. A small separate enclosure, to be worn on a belt for example, may hold a power source and a circuit board with signal-processing hardware.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic block diagram of a sonar-based acoustic mobility aid in accordance with an embodiment of the present invention;

FIG. 2 is a diagram depicting a physical arrangement of components of the acoustic mobility aid; and

FIG. 3 is a waveform diagram illustrating the frequency spectra of signals employed in the acoustic mobility aid

### DETAILED DESCRIPTION

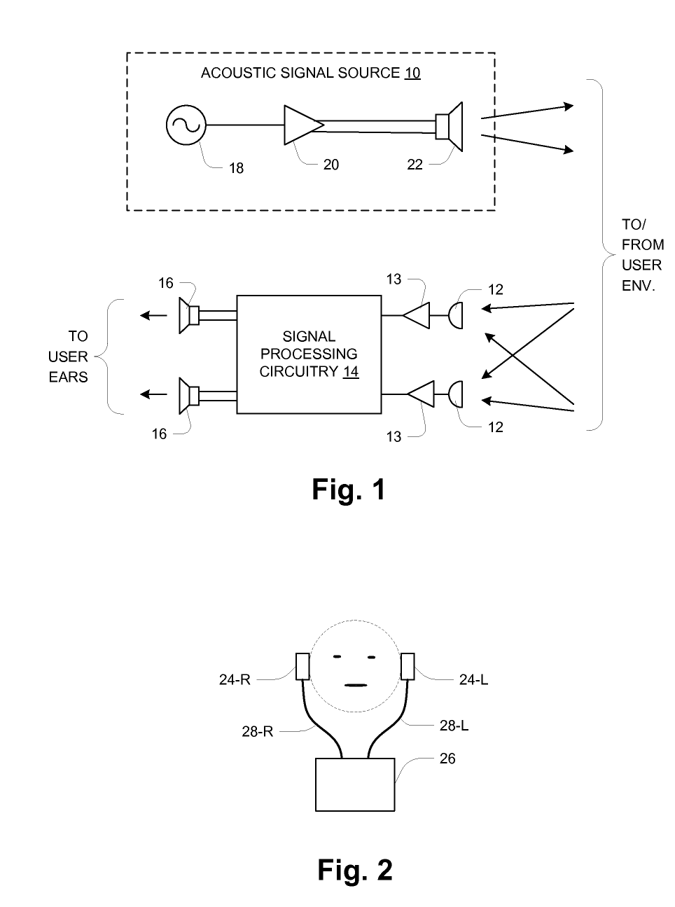

FIG. 1 shows an acoustic mobility aid including an acoustic signal source 10, an array of microphones 12, preamplifiers 13, signal processing circuitry 14 and speakers 16. The acoustic signal source 10 includes a signal generator 18, amplifier 20 and speaker(s) 22. All system components are worn by an individual such as a visually impaired person, referred to as a “user” herein. The microphones 12 are preferably worn so that they establish a beam pattern of sound reception that mimics the normal pattern of sound reception of the user, i.e., they are placed at or near the user's ears and oriented to receive sound radiating toward the user from the external environment (e.g., one microphone at each ear). The speakers 16 are placed at respective ears of the user, thus achieving separate left and right channels of operation.

In operation, the signal generator 18 generates broadband electrical signals in a supersonic frequency range having a “click” characteristic at periodic intervals (described in more detail below). In one embodiment, these signals have a frequency spectrum with a center frequency in the range of 30 kHz to 50 kHz and a bandwidth in the range of 5 kHz to 20 kHz. The electrical signals are amplified by amplifier 20 and the amplified signals are supplied to one or more speakers 22 which convert the amplified electrical signals into corresponding supersonic acoustic signals and direct these supersonic acoustic signals into the surrounding environment of the user. The supersonic acoustic signals are reflected from objects in the environment, and some of the reflected acoustic signals (referred to as “echoes”) are directed back toward the user. These reflected acoustic signals are converted by the microphones 12 into corresponding electrical signals which are amplified by the preamplifiers 13, and the amplified signals are processed by the signal processing circuitry 14. In particular, the signal processing circuitry performs a heterodyning function to shift the frequency spectrum of the signals in each channel into the audible range. The frequency shifted signals are supplied to the user's ears by the speakers 16.

Generally, it is desired that the amplitude of the sonar signals be as high as possible to maximize the level of the echo signals received by the microphones 12. There may be practical limits to the signal amplitude, including limits based on health and safety concerns. For example, it may be desired or necessary to employ a signal amplitude less than 115 db in one embodiment. Regarding the rate of the clicks, it is believed that a rate in the range of 1 to 5 per second can provide for good echolocation by a user.

The user obtains a number of auditory spatial cues from the echoes. Two types of cues includes interaural time differences (ITD) and interaural level differences (ILD). The timing between the source clicks and the echoes can be used to judge distance, and therefore it may be desirable for the signal processing circuitry to reproduce an acoustic version of the clicks emitted by the source 10. In some embodiments the inclusion of the source clicks may be user-selectable. The user also obtains information from the presence of reverberation and the shape of the spectrum of the echoes. The spectrum is shaped by the so-called head-related transfer function (HRTF) of the user which establishes certain “notches” (points of low signal intensity) in the frequency spectrum. These notches provide cues to the elevation of the echoes. These notches may be enhanced by filtering used by the signal processing circuitry 14.

FIG. 2 illustrates one general type of physical partitioning of the acoustic mobility aid of FIG. 1. Left-ear and right-ear components 24-L and 24-R each include a respective one of the microphones 12, preamplifiers 13 and speakers 16. Each microphone 12 is placed near a respective ear of the user to receive acoustic signals from the environment, and each speaker 16 is placed at the opening of the user's ear to direct acoustic sound signals into the ear. The components 24-L and 24-R are coupled to a central component 26 by respective connections 28-L and 28-R, which may be wired or wireless in alternative embodiments. The central component 26 includes a power source as well as electronic circuitry that implements the acoustic signal source 10 and the signal processing circuitry 14. The electronic circuitry may be mounted on a printed circuit board and may utilize an integrated-circuit digital signal processor (DSP) of the type generally known in the art. The DSP can be programmed to realize the signal generator 18 as well as the signal processing function of the signal processing circuitry 14. In the event that the connections 28 are wireless, suitable wireless communications circuitry is included within the central component 26 and the per-ear components 24-L and 24-R.

The speakers 16 are preferably of the open type which permit ambient sound to enter the ear along with the acoustic signal being reproduced. In one embodiment the speakers 16 may be realized using conventional headphones or earbuds. If an off-the-shelf headset is employed, it may be desirable to include a suitable jack on the central component 26 for receiving a corresponding plug from the headset. The microphones 12 are preferably miniaturized and mounted very close to the user's ear. For example, they may be mounted in a behind-the-ear enclosure similar to a hearing aid or they may be mounted on a frame worn by the user which may be actual or mimicked eyeglass frames. In one embodiment, the speaker(s) 22 of the source 10 is/are located on the central component 26, but in alternative embodiments it may be desirable to include the speaker(s) 22 in the per-ear components 24 (e.g., one speaker 22 per channel). However mounted, it is desirable that the speakers 22 be oriented to direct sound in a generally forward direction to enable echo-location of objects in the normal path of the user's motion. When the speaker(s) 22 are included in the central component 26, it is desirable that the central component 26 be worn on a generally front-facing part of the user's body such as the of a belt etc.

The left and right components 24-L and 24-R may include miniature pinnae or ear-like structures which can enhance directionality and spectral response characteristics of the system. For example, a forward-facing cup-like structure may be employed to provide greater sensitivity to the echoes directed at the front of the user than other echoes.

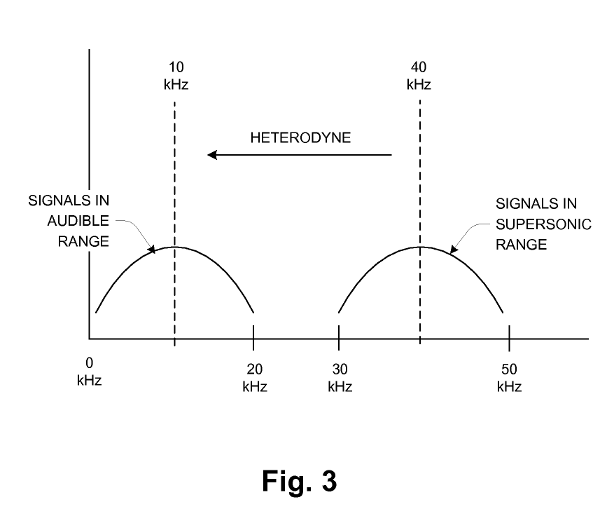

FIG. 3 illustrates in a generalized form the signal spectra employed in at least one embodiment. The supersonic acoustic signals generated by the source 10 and received by the microphones 12 occupy a broad area in the range of 30 kHz to 50 kHz, with a nominal center frequency of about 40 kHz. Generally, the acoustic click signals have a pulse-like characteristic in the time domain, which translates into a broad signal spectrum in the frequency domain. The rounded curve shown in FIG. 3 is intended to represent this spectrum only in general, not in any pertinent detail. It will be appreciated that the details of the spectrum may vary in different embodiments. Pulse-like signals are generally preferred because (1) their timing is known more precisely, enabling the user's brain to more readily identify distinct echoes that convey distance information, and (2) their broadband nature permits identification of a variety of objects of different shapes and sizes. In one embodiment, the acoustic click signals may be synthesized as so-called “Gabor” functions.

As illustrated in FIG. 3, the received supersonic signals are shifted down to the range of 0 kHz to 20 kHz by the signal processing circuitry 14. The technique of heterodyning is generally known in the art and is not elaborated here. It will be appreciated that the heterodyning may impart undesired phase shift or other distortion to the received signals, in which case it may be desirable to include signal conditioning filtering within the signal processing circuitry to correct for any such distortion. It may also be desirable to employ filtering to enhance certain characteristics of the received signal for better performance. For example, it is known that elevation cues are derived from discerning the location of “notches” (areas of relative low amplitude) of the received signal spectrum. Signal filtering can be used to enhance the depth of notches relative to average signal level, making the elevation cues more readily discernible.

While this invention has been particularly shown and described with references to preferred embodiments thereof, it will be understood by those skilled in the art that various changes in form and details may be made therein without departing from the spirit and scope of the invention as defined by the appended claims.

What is claimed is:

1. An acoustic mobility aid, comprising:
a wearable source of broadband, supersonic, acoustic click signals including one or more speakers operative to direct the acoustic click signals into a local environment of an individual;
a wearable array of supersonic microphones operative to respond to acoustic signals in a frequency range of the supersonic acoustic click signals, the array including at least one microphone wearable at each ear of the individual and being configured to establish a frequency-dependent beam pattern that mimics a beam pattern of human ears;
wearable signal processing circuitry operative in response to output signals of the microphones to apply heterodyning to frequency-shift the output signals of the microphones to generate corresponding frequency-shifted signals in an audible frequency range; and
a wearable set of speakers operative to convert the frequency-shifted signals into audible acoustic signals directed at the ears of the individual.

2. An acoustic mobility aid according to claim 1, wherein the wearable set of speakers comprises open headphones permitting ambient sound to also reach the ears of the individual.

3. An acoustic mobility aid according to claim 1, further comprising a frame for mounting on the head of the individual during use, the frame supporting at least the array of supersonic microphones.

4. An acoustic mobility aid according to claim 3, wherein the frame mimics eyeglass frames.

5. An acoustic mobility aid according to claim 3, wherein the frame further supports preamplifiers for amplifying the output signals from the microphones and generating pre-amplified signals for processing by the signal processing circuitry.

6. An acoustic mobility aid according to claim 3, further comprising a wearable central component including at least the signal processing circuitry.

7. An acoustic mobility aid according to claim 1, wherein the broadband, supersonic acoustic click signals occupy a frequency spectrum in the range of 30 kHz to 50 kHz.

8. An acoustic mobility aid according to claim 1, wherein the frequency-shifted signals from the signal processing circuitry include audible versions of the supersonic acoustic click signals from the source to enable the user to judge the distance of objects based on a time delay between generated click signals and echo click signals.

9. An acoustic mobility aid according to claim 8, wherein the inclusion of the audible versions of the supersonic acoustic click signals is user-selectable.

10. An acoustic mobility aid according to claim 1, wherein the signal processing circuitry is operative to apply filtering to the frequency-shifted signals to enhance signal features that provide object location cues to the individual.

11. An acoustic mobility aid according to claim 10, wherein the filtering includes enhancement of spectral notches providing elevation cues.

12. An acoustic mobility aid according to claim 1 further comprising pinnae on which the array of microphones are mounted to provide at least a portion of the beam pattern.

13. An acoustic mobility aid according to claim 1, wherein the acoustic click signals are emitted at a rate in the range of 1 to 5 per second.

14. An acoustic mobility aid according to claim 1, wherein the signals from the microphones are time windowed by zeroing signals received immediately after an emitted acoustic click signal as well as signals received after a time interval corresponding to a maximum desired range.

15. A method of aiding individual echo-location, comprising:
generating broadband, supersonic, acoustic click signals and directing the acoustic click signals into a local environment of an individual;
receiving acoustic signals in a frequency range of the supersonic acoustic click signals at the individual and converting the received acoustic signal into corresponding electrical signals;
processing the electrical signals to apply heterodyning to frequency-shift the electrical signals to generate corresponding frequency-shifted signals in an audible frequency range; and
converting the frequency-shifted signals into audible acoustic signals and directing the audible acoustic signals at the ears of the individual.

16. A method according to claim 15, wherein the broadband, supersonic acoustic click signals occupy a frequency spectrum in the range of 30 kHz to 50 kHz.

17. A method according to claim 15, wherein the frequency-shifted signals from the signal processing circuitry include audible versions of the supersonic acoustic click signals from the source to enable the user to judge the distance of objects based on a time delay between generated click signals and echo click signals.

18. A method according to claim 17, wherein the inclusion of the audible versions of the supersonic acoustic click signals is user-selectable.

19. A method according to claim 15, further comprising applying filtering to the frequency-shifted signals to enhance signal features that provide object location cues to the individual.

20. A method according to claim 19, wherein the filtering includes enhancement of spectral notches providing elevation cues.
